(19) United States
(12) Patent Application Publication
(10) Pub. No.: US 2018/0018641 A1
(43) Pub. Date: Jan. 18, 2018

(54) METHOD OF ESTIMATING AN EXPECTED SERVICE LIFE OF A COMPONENT OF A MACHINE

(71) Applicant: Liebherr-Werk Nenzing GmbH, Nenzing (AT)

(72) Inventors: Patrick JUSSEL, Bludenz (AT); Michael KOCHER, Bludenz (AT)

(21) Appl. No.: 15/637,195

(22) Filed: Jun. 29, 2017

(30) Foreign Application Priority Data
Jul. 18, 2016 (DE) 10 2016 008 750.1

(51) Int. Cl. G06Q 10/00; G06K 9/62; G06F 11/00

(52) U.S. Cl. CPC G06Q 10/20; G06F 11/008; G06K 9/62

(57) ABSTRACT

A method of estimating an expected service life of a component of a machine includes recording process data of the machine that are detected by the machine on the carrying out of a cyclic workstep. The detected data are transmitted to a database that analyzes the data stored in the database for failure patterns in accordance with a failure pattern catalog to estimate the expected service life of the component, and a communication is output on a location of a recognized failure pattern in the analyzed data.

### CROSS REFERENCE TO RELATED APPLICATION

This application claims priority to German Patent Application No. 10 2016 008 750.1, entitled “Method of Estimating an Expected Service Life of a Component of a Machine,” filed Jul. 18, 2016, the entire contents of which are hereby incorporated by reference for all purposes.

### TECHNICAL FIELD

The present disclosure relates to a method of estimating an expected service life of a component of a machine.

### BACKGROUND AND SUMMARY

There are a large number of machines that are adapted to repeat a high number of similar cyclic worksteps. A crane, an excavator, a reach stacker or also a wheeled loader could be named here, for example, that all have the common feature of carrying out cyclic worksteps over a long time period.

To be able to ensure the functionality of such a machine over a longer time period, servicing intervals typically have to be observed on whose non-observance the likelihood of a failure or of damage to the machine or to a component of the machine greatly increases. This is in particular disadvantageous when such a machine is integrated into a complex working procedure and when the failure of just one machine has effects on the total complex working procedure. It is therefore particularly advantageous to be able to reliably estimate the expected service life of a component of a machine to be able to carry out maintenance or a replacement of a component at the machine at a suitable point in time. This reduces unplanned down times such that the complex working procedure can in particular be completed faster and with higher reliability overall.

One example method of estimating an expected service life of a component of a machine in accordance with the present disclosure includes recording process data of the machine that are detected by the machine on the carrying out of a cyclic workstep. The detected data are then transmitted to a database that analyzes the data stored in the database for failure patterns in accordance with a failure pattern catalog, to estimate the expected service life of the component and to output a communication on a location of a recognized failure pattern in the analyzed data.

It is thereby possible to estimate the expected service life in components in a machine (for example in a crane, an excavator, a wheel loader or a reach stacker) and thus to provide the basis for a fully automated predictive maintenance in a wider sense. The process data of the machine accrued on the carrying out of a cyclic workstep are recorded and analyzed for the estimation of the expected service life of a component.

In accordance with an optional further development of the disclosure, the data are continuously transmitted to the database over the total service life of the machine or of the component, with the data optionally being transmitted at regular time intervals. A particularly well-founded estimate of the service life to be expected of a component can be made by the presence of process data that extend over the total prior service life of a component. Effects that took place, in a time aspect, long before the actual failure of the component can also be taken into account in accordance with the disclosure, in particular with respect to the black box system widespread in the prior art in which data are only analyzed after the event for a specifically limited time period before a failure. The continuous chronology of the process data with respect to a component of the machine enables a precise mapping of the actual condition of the component.

In accordance with a further optional modification of the disclosure, a report on a failure of a component of the machine is furthermore also transmitted to the database in the method. A conclusion can then be drawn on a failure pattern, which is added to the failure pattern catalog, by the report on a failure of a component transmitted to the database.

For example, after a determination of a failure, an anomaly such as an operation of a component above permitted limit values that occurred long before the time of failure can thus also be considered as causal for the failure of the component.

Provision can furthermore be made that the database is arranged at a location remote from the machine and that is optionally a decentralized database or a cloud based database.

In accordance with a further development of the disclosure, the process data are combined with independent reports generated by the machine itself, with the independent reports generated by the machine optionally being transmitted to the database for this purpose.

In this respect, the process data and the reports generated by the machine itself can be considered both separately and in combination with one another and can be searched for patterns, anomalies and irregularities, optionally by cluster algorithms and machine learning algorithms.

The machine optionally carries out a plurality of cyclic worksteps and the process data comprise a data record for every single one of the cyclic worksteps, with the data record optionally being generated with the aid of an algorithm.

Provision can furthermore be made in accordance with the disclosure that the communication on the location of a recognized failure pattern in the analyzed data includes an estimate on the expected service life of a component and/or proposes a time for maintenance or replacement of the component. It can thereby be ensured that a component facing an imminent failure can be serviced or replaced in good time. This can prevent an unplanned interruption of the machine using a component such that a working procedure using the machine does not have to be interrupted in an unplanned manner.

In addition, in accordance with one embodiment of the disclosure, provision can be made that the process data are weighted by the reports generated by the machine itself on the analysis of the data stored in the database to increase the reliability on an estimate of the expected service life.

The reports generated by the machine itself are, for example, optionally overload reports from crane, a report on an empty fuel tank or energy tank, problems with sensors, defects in the system and/or status messages of assistance systems.

In accordance with a further development of the present disclosure, the process data are relative or absolute starting positions and end positions of a machine part or of the machine in at least two spatial dimensions, speeds of the different machine components, loads, maximum and minimum powers, fuel consumption or energy consumption, temperatures of individual machine components, the operating age or the operating hours of a component, the previous service life of a component and/or hydraulic conditions in the machine.

Process data describe the condition of a machine or of a component, whereas a first evaluation by the machine is carried out on the reports generated by the machine itself

The analysis of the data stored in the database is optionally carried out in the ongoing operation of the machine.

In accordance with a further optional modification of the disclosure, the analysis of the data stored in the database and/or the estimate of an expected service life of a component is carried out in dependence on the previous service life, with the total previous service life optionally not being used, but only those time periods since the first putting into operation in which the component was actively in use.

In accordance with a further development of the disclosure, the analysis of the data stored in the database and/or the estimate of an expected service life of a component is/are carried out on the basis of the previous operating hours of a component that are weighted differently with reference to the process data and/or to the reports generated by the machine. An estimate of the expected service life of a component thereby does not take place rigidly using the operating hours already elapsed, but overload reports of a component can, for example, result in an expected service life smaller overall. Operating hours in which the component was operated in an overload range can thus be weighted more by a specific factor X in the estimate of the expected service life.

The disclosure additionally relates to a method in accordance with one of the preceding claims, wherein the machine is a crane, for example a harbor mobile crane, a construction machine, for example an excavator, a unit for drilling and foundation work, for example a pile driving machine or a floor-borne vehicle, for example a reach stacker.

Further features, advantages and details of the disclosure will become evident with reference to the Figures described in the following.

### BRIEF DESCRIPTION OF THE FIGURES

FIG. 1A schematically depicts an exemplary machine and control system thereof in accordance with the present disclosure.

FIG. 1B depicts a diagram for illustrating a method in accordance with the present disclosure;

FIG. 2 depicts a plan view of an exemplary machine in accordance with the present disclosure along with loading and unloading points of the machine;

FIG. 3 corresponds to the plan view of FIG. 2 and further depicts outlines of regions in which loading and unloading points are clustered; and

FIG. 4 depicts a diagram for visualizing the present disclosure with reference to an example of rope pulleys.

### DETAILED DESCRIPTION

One aspect of the present disclosure is the statistical calculation of service life parameters in components in a machine that can be used as the basis for a fully automated predictive maintenance. The basis for this is a combination of different data sources such as the operating hours and the service data that provide information on failures and the process data from machine cycles that permit conclusions on possible indicators for such failures in combination with messages generated by the machine after the failure of a component. In this respect, process data describe parameters of a single work cycle of the machine, for example the position on the raising of a load, the mass of the load, the average oil temperature during the moving of the load, the cycle time, and similar. Messages generated by the machine are in this respect, for example, information on overloads or problems in the electronics. The combination of process data with the messages generated by the machine allows extended details to be added to individual processes of the machine so that patterns that are causal for the failure can be recognized after the failure of a component. A pattern recognized in this manner can be utilized in the further process to recognize a failure similar in nature in other units at an early time.

It is typical for a larger number of machines that their work is carried out in always recurring cycles. For the detection of the summarizing process data, the machine cycles are determined in ongoing operation by an algorithm and a collection of all relevant data is calculated for every single cycle. These process data characterizing a work cycle can inter alia comprise absolute and/or relative starting positions and end positions in all dimensions, speeds of the different machine components, loads, maximum and minimum power, consumption, temperatures of the individual machine components, hydraulic conditions and/or material stress cycles. At the end of a cyclic workstep, these data are transmitted to a central location such as a database or a database server.

The above-described procedure will be explained with reference to an example of a harbor mobile crane. In this respect, the collected data on the unloading of a ship by a harbor mobile crane, for example, comprise the loading and unloading positions and the transported load for each cycle. The coordinates and dimensions of the different loading objects and unloading objects that can, for example, be a hatch, a hopper or a stack are in this respect determined with the aid of a cluster analysis with reference to the position data. The characteristic extent and the position of the different loading positions and unloading positions are in this respect compared with hypotheses to carry out a corresponding association with the corresponding loading objects and unloading objects (hatch, hopper or stack). A complete working day of a harbor mobile crane can thereby be reconstructed by a very small number of data.

Furthermore, reports of the machine independent of these process data are recorded that are transmitted to the same central location (database) and are optionally synchronized with the process data. These reports generated by the machine can, for example, be overload reports of a machine, a report on an empty tank, reports on problems with sensors, reports on defects in the system and/or status reports from assistance systems. This further information can be searched for sequential patterns or anomalies to permit additional conclusions. In addition, the reports generated by the machine or this information are/is added to the process data.

Furthermore, damage profiles are present for individual components of the machine and were prepared after a failure of a component. The process data of the machine cycles and the machine reports are looked at both separately and in combination with one another for the preparation and are searched for patterns, anomalies and irregularities. The searching can in this respect take place via cluster algorithms and machine teaming algorithms.

The result of these calculations are, on the one hand, the statistically determined service life parameters of a component type as well as a collection of failure patterns (damage profiles) that were found on failures of components. These failure patterns can, on the one hand, represent sequential patterns of machine reports, but also deviations in typical process data in machine cycles.

The above will be explained again for the example of a harbor mobile crane. If, for example, a hoisting winch in a harbor mobile crane has failed after X operating hours, the continuous recording of data now not only permits the operating hours of the crane to be taken up as the basis, but also to reduce the operating hours to the actually relevant time by the collected data of the cyclic worksteps of the harbor mobile crane, in which time the hoisting winch has actually been used. Individual cyclic worksteps can be weighted more or, alternatively thereto, they can be weighted less when working without load due to the expanded data (process data or reports generated by the machine). The relevant Y operating hours of the hoisting winch can be reconstructed from the X operating hours of the crane, whereby the prediction of an imminent failure can be determined more precisely with the aid of the continuous observation of these Y operation hours of the hoisting winch.

To the extent that the database includes sufficiently large statistics for an individual component type, a search can be made in a further sequence for the above-found failure patterns and irregularities in ongoing operation to recognize an imminent component failure in good time and to take corresponding counter-measures in good time.

If it is, for example, found in a harbor mobile crane after a failure of a component that, from a specific number of operating hours, a combination of machine reports within a specific work cycle at a larger rotational speed and with a large load very frequently results in an early failure of the component, exactly this failure pattern is continuously sought in a further sequence in all the cranes in operation. On a location of this failure pattern, a repair or a service of the critical component is initiated. The process data of work cycles, synchronized machine reports, cluster algorithm system for identifying the work cycles and pattern recognition or machine learning algorithms are typically used for such a method.

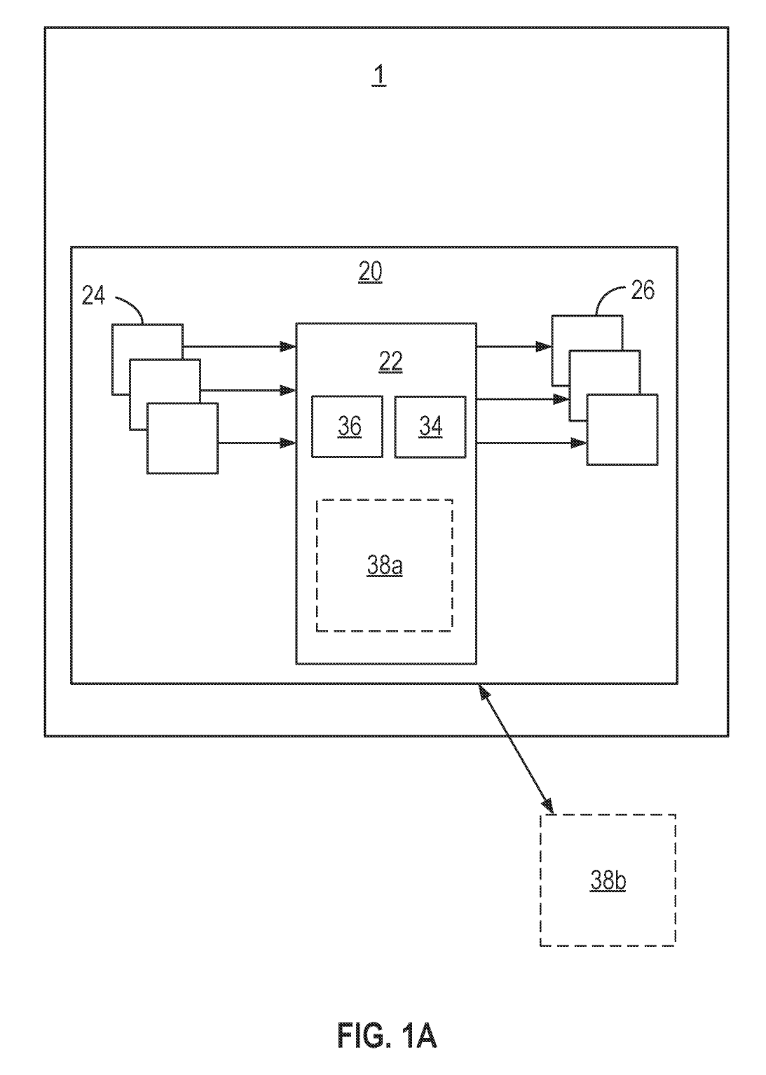

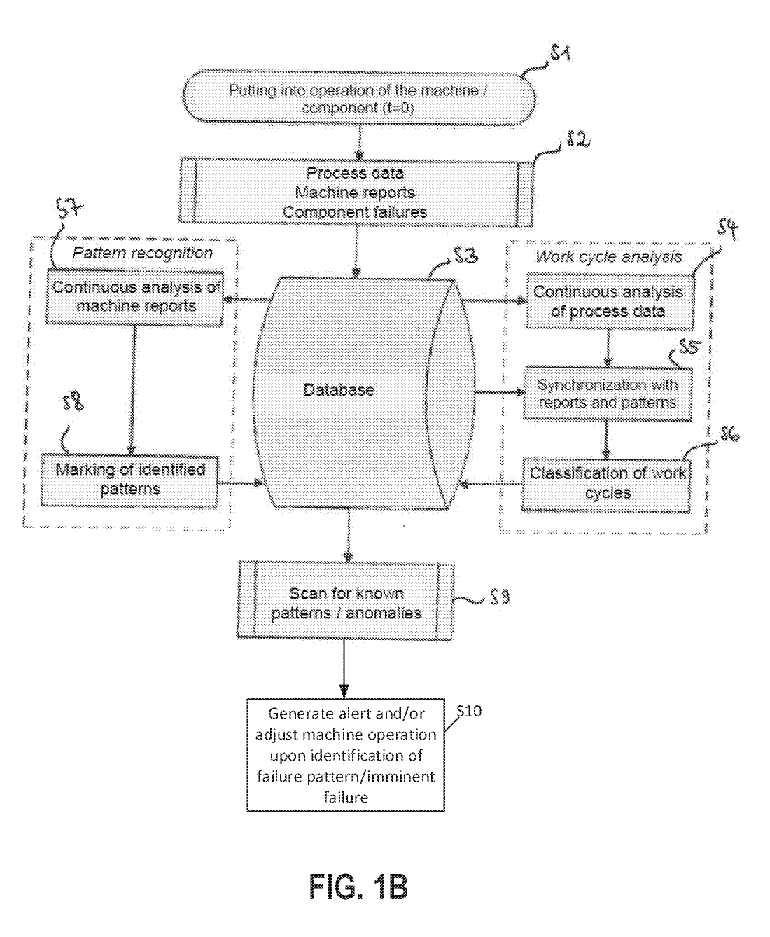

FIG. 1A schematically shows a machine 1 (e.g., harbor mobile crane) in accordance with the present disclosure. Machine 1 includes a control system 20. Control system 20 includes a control unit 22 communicating with sensors 24 and actuators 26. Control unit 22 includes a processor 34 and non-transitory memory 36, the non-transitory memory having instructions stored therein for carrying out the various control actions described herein, including control actions associated with the workflow diagram shown in FIG. 1B. Control unit 22 receives signals from sensors 24 and sends signals to actuators 26 to adjust operation of the various components of the machine, based on the received signals and the instructions and other data stored in the non-transitory memory 36.

Sensors 24 may include, for example, sensors detecting process data reflecting the condition of machine 1 or the condition of components of machine 1. For example, sensors 24 may include sensor detecting he relative or absolute starting positions and end positions of a machine part or of the machine in at least two spatial dimensions, speeds of the different machine components, loads, maximum and minimum powers, fuel consumption or energy consumption, temperatures of individual machine components, the operating age or the operating hours of a component (e.g., hoisting winch), the previous service life of a component and/or hydraulic conditions in the machine. Further, the process data detected by sensors 24 may describe parameters of a single work cycle of the machine, for example the position on the raising of a load, the mass of the load, the average oil temperature during the moving of the load, the cycle time, and similar.

Actuators 26 may include mechanical actuators, pneumatic actuators, thermal actuators, and the like which are associated with the components of the machine (e.g., actuators which effect movement of the boom of a harbor mobile crane, adjust operation of a rope pulley, open and close a gripper to load/unload objects, etc.).

In the depicted example, the control system includes a database 38a and/or a database 38b. Database 38a is stored in non-transitory memory of control unit 22, such that the data in database 38a is physically stored at machine 1. In contrast, database 38b is physically stored in non-transitory memory at a location remote from machine 1, and thus is a decentralized database or a cloud based database. Database 38b communicates wirelessly with control system 20, e.g. via a server over a network.

FIG. 1B shows a workflow diagram of the method in accordance with the disclosure. Instructions for carrying out the method shown in FIG. 1B may be executed by a processor (e.g., processor 34 of control system 20) based on instructions stored in non-transitory memory (e.g., non-transitory memory 36) and in conjunction with signals received from sensors (e.g., sensors 24). The control system may employ actuators (e.g., actuators 26) to perform actions associated with the method.

S1 describes the putting into operation of the machine or of the component. Process data, machine reports and component failures are subsequently continuously sent to the database S3 (which may correspond to database 38a and/or 38b shown in FIG. 1A) in step S2 over the total service life of the machine or of the component. This carries out a continuous analysis of the process data in S4 and synchronizes it with reports generated by the machine itself and with patterns S5. The different work cycles carried out by the machine are classified in step S6.

The machine reports are furthermore subjected to a continuous analysis S7 and in so doing discovered identified patterns are marked S8.

In addition, at S9, a search is made in data stored in the database for known patterns/irregularities/anomalies to recognize an imminent failure of a component as soon as possible.

At S10, upon identification of a failure pattern/imminent failure of a component, an alert is generated and/or machine operation is adjusted. For example, based on the results of the scan performed at S9, the control system may generate an alert to an operator of the machine (e.g., an audio or visual alert). The alert may indicate which component(s) are failing or are likely to fail within a predetermined time frame. Additionally or alternatively, the control system may adjust machine operation (e.g., via actuators 26) responsive to identification of a failure pattern or imminent failure. This may include arresting movement of one or more machine components, limiting movements of one or more machine components to within predetermined limits, etc.

The following example describes how a harbor mobile crane in a harbor unloads a ship into a hopper and onto a stack disposed next to it and how the combined information of the process data and of the machine data are used for predictive maintenance.

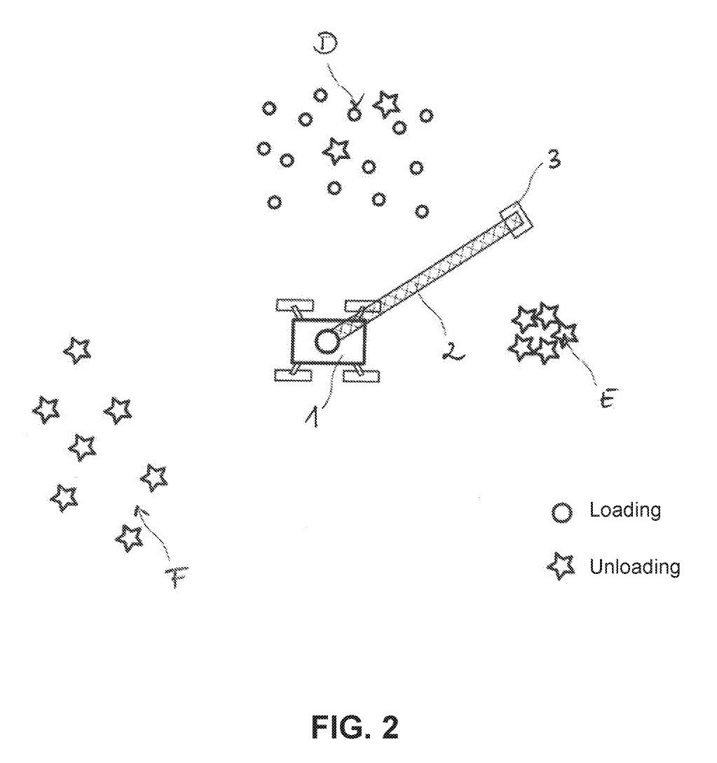

As shown in FIG. 2, a harbor mobile crane 1 stands at a specific point. The crane unloads a ship using the boom 2 and an attached bucket 3. Specific data, for example, the coordinates in 2 dimensions, at which the bucket is filled (circles) and emptied (stars), can be collected per cycle by means of cycle recognition. Three rough areas can already be recognized with the eye in FIG. 2: Region D in which mainly the bucket is filled; region E in which the bucket is always unloaded in a highly localized manner; and region F in which the bucket is always unloaded with a larger scatter. Machine data are furthermore recorded that are searched through for patterns, on the one hand, and that are synchronized with the process data. Finally, the failure times of machine components are also detected; here, for example, the time at which a pulley fails.

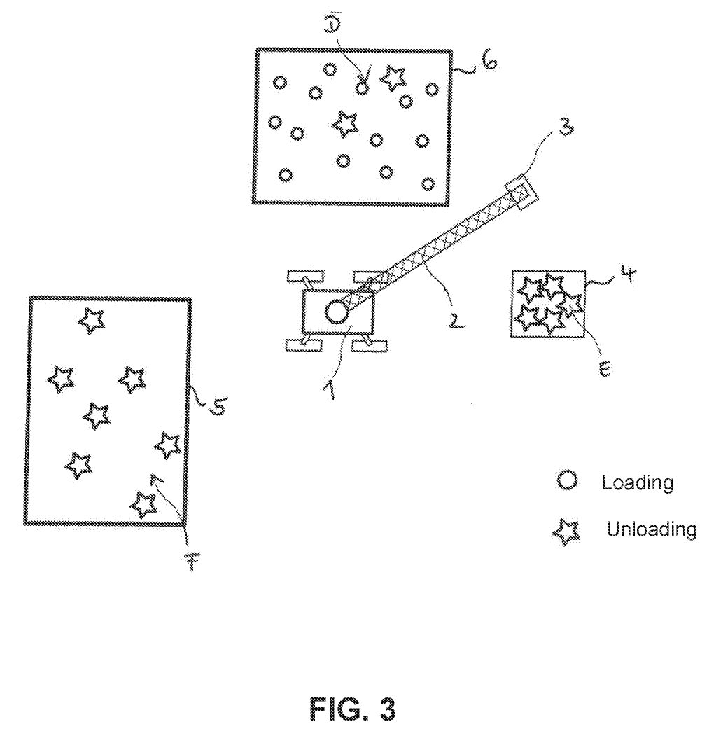

It is determined in a further sequence by the analysis of the existing process data (e.g. by a clustering of the known positions by means of a conventional cluster algorithm) which accumulations of loading points and unloading points can be assigned to which real objects. As shown in FIG. 3, it can thus be determined by the small scatter of the unloading points in E that the real object very probably has to be a hopper, while the great scatter at F rather allows a conclusion on a stack. The many loading points at D allow a conclusion of the position of the ship. In the depicted example, region D is defined by outline 6, region E is defined by outline 4, and region F is defined by outline 5. Outlines 4, 5, and 6 and the area within each outline may be determined by the control system. The control system may then determine a corresponding real object for each region based on (e.g., as a function of) the area within the outline of the region and/or the 2-dimensional coordinates of the region relative to the crane. For example, a lookup table may be stored in memory of the control system which relates scatter area and/or 2-dimensional coordinates relative to the crane to probable real objects.

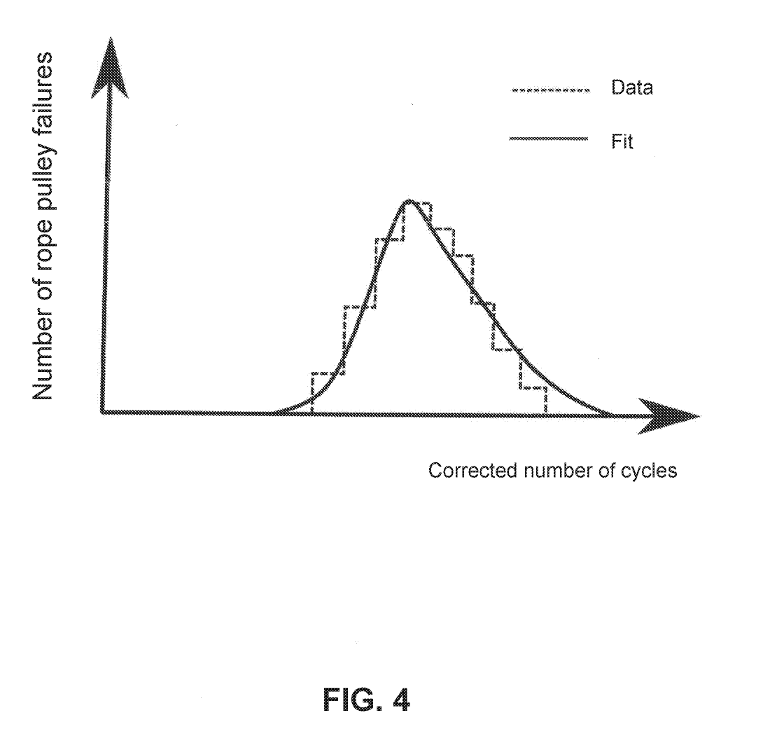

This information is continuously recorded for a number of harbor mobile cranes. It is thus known how many transfers harbor mobile cranes carry out at which loads during operation and how often overload reports are recorded in so doing. In this example, in a further sequence, it is found by a sequential pattern recognition that on a great frequency of overload reports, the rope pulleys fail earlier with harbor mobile cranes. It can, for example, be determined by a fit of the data that an overload report approximately represents the same load for a rope pulley as 30 regular work cycles (cf. FIG. 4). This knowledge is now further processed to calculate the failure probability of a rope pulley not only in dependence on its prior service life, but also in dependence on a corrected, weighted number of work cycles. For example, the work cycles may be weighted based on the load of each work cycle, such that a number of work cycles is weighted differently than the same number of work cycles but with different loads.

Once a sufficient number of process data, machine data, and failure data have been collected, the current state of the rope in the harbor mobile cranes can be calculated in a further sequence: how many cycles had already been absolved, how many cycles will the rope pulley still survive with which probability, and how much the forecast failure is influenced by overloading.

Note that the example control methods included herein can be used with various machine configurations. The control methods disclosed herein (e.g., the method shown in FIG. 1B) may be stored as executable instructions in non-transitory memory and may be carried out by the control system of the machine, including the control unit in combination with the various sensors, actuators, and other hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the control system, where the described actions are carried out by executing the instructions in a system including the various components in combination with the control system.

1. A method of estimating an expected service life of a component of a machine, comprising:
detecting process data of the machine while carrying out a cycle workstep by the machine;
recording the detected process data;
transmitting the detected process data to a database;
analyzing the process data stored in the database for failure patterns in accordance with a failure pattern catalog to estimate the expected service life of the component; and
outputting a communication on a location of a recognized failure pattern in the analyzed process data.

2. The method in accordance with claim 1, wherein the process data are continuously transmitted to the database over a total service life of the machine or of the component; and wherein the process data are transmitted at regular time intervals.

3. The method in accordance with claim 1, further comprising transmitting a report on a failure of the component of the machine to the database; and wherein a conclusion is drawn by the report on a failure pattern of the failure of the component, and the failure pattern catalog is expanded by this failure pattern.

4. The method in accordance with claim 1, wherein the database is arranged at a location remote from the machine and is a decentralized database or a cloud based database.

5. The method in accordance with claim 1, wherein the process data are combined with independent reports generated by the machine itself, with the independent reports generated by the machine being transmitted to the database for this purpose.

6. The method in accordance with claim 5, wherein the process data and the independent reports generated by the machine itself are considered both separately and in combination with one another, the method further comprising searching the process data and the independent reports for patterns, anomalies and irregularities.

7. The method in accordance with claim 1, wherein the machine carries out a plurality of cyclic worksteps and the process data comprise a data record for every single one of the cyclic worksteps, with the data record being generated via an algorithm.

8. The method in accordance with claim 1, wherein the communication on the location of a recognized failure pattern in the analyzed process data includes an estimate of the expected service life of the component and/or proposes a time for maintenance or replacement of the component.

9. The method in accordance with claim 5, wherein the process data are weighted by the independent reports generated by the machine itself on the analysis of the data stored in the database to increase the reliability of an estimate of the expected service life.

10. The method in accordance with claim 1, wherein the independent reports generated by the machine itself include one or more of overload reports from a crane, a report on an empty fuel tank or energy tank, reports on problems with sensors, reports on defects in the system, and reports on status messages of assistance systems.

11. The method in accordance with claim 1, wherein the process data are parameters of an individual cyclic workstep.

12. The method in accordance with claim 1, wherein the analysis of the data stored in the database is carried out during operation of the machine.

13. The method in accordance with claim 1, wherein the analysis of the data stored in the database and/or the estimate of an expected service life of the component is/are carried out in dependence on a duration of a previous service life of the component.

14. The method in accordance with claim 1, wherein the analysis of the data stored in the database and/or the estimate of an expected service life of the component is/are carried out on the basis of a number of previous operating hours of the component that are weighted differently with reference to the process data and/or to the reports generated by the machine.

15. The method in accordance with claim 1, wherein the machine is a crane, a construction machine, a unit for drilling and foundation work, or a floor-borne vehicle.

16. The method in accordance with claim 6, wherein the process data and the independent reports generated by the machine itself are searched for the patterns, anomalies and irregularities by cluster algorithms and/or machine learning algorithms

17. The method in accordance with claim 11, wherein the parameters include one or more of relative or absolute starting positions and end positions of a machine part or of the machine in all spatial dimensions, speeds of the different machine components, loads, maximum and minimum powers, fuel consumption or energy consumption, temperatures of individual machine components, the operating age or the operating hours of the component, the previous service life of the component, and hydraulic conditions in the machine.

18. The method in accordance with claim 13, wherein the previous service life is not a total previous service life, and instead includes only time periods since the component was first put into operation in which the component was actively in use.
